(19) United States
(12) Patent Application Publication
(10) Pub. No.: US 2012/0275799 A1
(43) Pub. Date: Nov. 1, 2012

(54) ELECTRIC ENERGY STORAGE SYSTEM FOR A VEHICLE

(75) Inventors: Simon Abraham, Berlin (DE); Sven Bergmann, Stuttgart (DE); Michael Schiemann, Berlin (DE); Hans-Georg Schweiger, Ingolstadt (DE)

(73) Assignee: CONTINENTAL AUTOMOTIVE GMBH, HANNOVER (DE)

(21) Appl. No.: 13/516,791

(22) PCT Filed: Dec. 9, 2010
(86) PCT No.: PCT/EP2010/069231

§ 371 Date: Jul. 13, 2012

(30) Foreign Application Priority Data
Dec. 18, 2009 (DE) 10 2009 058 879.5

(51) Int. Cl. H04B 10/04; H04B 10/12

(52) U.S. Cl. 398/200; 398/182; 398/201

(57) ABSTRACT

An electric energy storage system for a vehicle, such as an electric or hybrid vehicle. The energy storage system has multiple electric components and data transmission devices for transmitting data signals between the electric components. Here, the data transmission devices include at least one transmission link for electromagnetic radiation to transmit data signals.

The present invention relates to an electric energy storage system of a vehicle equipped with an electric drive, comprising a multiplicity of electric components and data transmission lines for transmitting data signals from and/or to at least one of the components.

The vehicle can be, in particular, a so-called hybrid or electric vehicle, which can be propelled wholly or partially by electric energy.

Hybrid vehicles have typically an internal combustion engine (e.g. gasoline or diesel engine), at least one electric machine (e.g. three-phase motor) and one or more electric energy stores (e.g. lead acid batteries, double-layer capacitors, nickel-metal hydride cells, nickel/zinc cells or lithium ion cells etc.).

In contrast, pure electric vehicles have only one or more electric machines for their propulsion. A special type of electric vehicle has a tank for a liquid or gaseous energy source (e.g. hydrogen), a fuel cell arrangement supplied from it for energy conversion and an electric energy store.

The electric machine of a hybrid vehicle is mostly constructed as starter/generator and/or electric drive. As a starter/generator, it replaces the starter and the alternator present in conventional vehicles with internal combustion engine. When it is used as an electric drive of the vehicle, additional torque for the propulsion of the vehicle can be contributed by the electric machine. When it is used as a generator, it provides for the recuperation of braking energy and the electric vehicle power supply.

Both types of vehicle, hybrid and electric vehicle, have in common that large amounts of electric energy have to be provided and transferred. The electric energy flow is controlled, as a rule, by means of special electronics. These electronics control, in particular, whether and in what amount energy is to be taken from or supplied to the electric energy store. The removal of energy from the energy store or from the fuel cell, respectively, can represent a driving power for the vehicle and/or supply the electric vehicle power supply system. The supply of energy serves to charge up the store, for instance as part of the recuperation of braking energy in the case of regenerative braking. In the case of a hybrid vehicle, it is also possible to provide energy needed for charging up the electrochemical energy store by means of the internal combustion engine.

In known electric energy storage systems of such a vehicle, an electronic communication bus (e.g. CAN bus) is typically used for communication or data transmission between the individual electric components of the energy storage system. As an alternative or additionally, single electric signal or data lines are also used. By this means, it is possible to transmit, for example, coded measured values for the individual voltages and/or individual temperatures of a multiplicity of single battery cells of the electrochemical energy store and/or of double-layer capacitors (DLC) of the electrostatic energy store as signal to a control device (e.g. hybrid controller or battery module controller).

In particular, the high accuracy of measurement required in the detection of measured variables in the area of the energy storage system requires an interference-proof transmission of the data signals via the bus system or the electric lines provided for this purpose.

However, since considerable currents flow in the area of the energy storage system which can reach e.g. 100 A or more in operation and there are also correspondingly large current variations, the electric lines or the electronic communication bus and its interfaces towards the respective components must be constructed correspondingly expensively, especially in order to avoid the data signals (e.g. measured values) from being influenced by electromagnetic disturbances.

It is an object of the present invention to improve an electric energy storage system of the type initially mentioned with regard to the operational reliability.

According to the invention, this object is achieved in that the data transmission devices include at least one transmission link for electromagnetic radiation to transmit data signals.

Such a transmission link can be constructed, in particular, e.g. as an optical waveguide for the optical transmission of data signals.

As an alternative or additionally, it is also possible to use, e.g., light barriers, optocouplers or the like, in each case with a corresponding signal source and a receiver for the electrical/optical conversion.

In the narrower sense, the term “optical waveguide” designates an arrangement of one or more elongated media which are suitable for the propagation (and thus transmission) of electromagnetic waves. This term thus includes, e.g., in particular, an arrangement of one or more optical fibers, plastic fibers etc. which are sufficiently transparent in the range of electromagnetic wavelengths used and in which there can be, e.g., a certain wave guidance (e.g. due to total reflection).

In one embodiment of the transmission link provided for the transmission of electromagnetic radiation as a light barrier, optocoupler or the like, such a medium is unnecessary or the medium can be formed by the air between the relevant communication partners or between transmitter and receiver, respectively.

In the text which follows, for the sake of simplicity of the description, the terms “optical waveguide” and “fiber optics” are intended to be understood not only in the above narrower sense but also in a wider sense as synonym for an optical transmission link or an optical signal transmission technology, respectively.

Using fiber optics makes it possible to achieve an insensitivity of the data transmission to electromagnetic disturbances in the signal transmission in the energy storage system since the signals are transmitted electromagnetically (e.g. optically) and not electrically. This form of data signal transmission therefore represents a much more reliable path compared with a conventional electronic bus system. In particular, electromagnetic disturbances caused by DC/DC and/or DC/AC convertors of the electric energy storage and drive system of the vehicle do not represent a problem for the optical data transmission.

In particular, the electric energy storage system can be used for a pure electric vehicle (EV) or a hybrid vehicle (HEV) including a so-called plug-in hybrid vehicle (PHEV).

At least one of the electric components of the energy storage system can be the storage component for electric energy, for instance an electrochemical or electrostatic energy store of one of the types already mentioned above.

Such a battery can be designed with a rated voltage (in the loaded state) of more than 100 V, particularly more than 300 V and/or with an operational current rating for the vehicle drive of more than 100 A (and, e.g., any possible short-term peak currents of more than 500 A).

Such a high battery voltage also results in high demands on safety, either with regard to the risk of electric short circuits or the risk of fatal injury, for example to workshop personnel, if it is possible to touch electric line components which are under voltage. In this regard, the invention provides the special advantage that due to the zero-potential optical signal transmission by means of optical waveguide, the high-voltage safety can be increased and the hazard in handling the energy storage system can be reduced for persons (e.g. during an examination or opening of defective components of the energy storage system).

Each of the optical waveguides used according to the invention can be connected to the relevant component, e.g. via a plug-in connector. In this regard, a special advantage of the invention consists in the lower sensitivity of such plug-in connections with respect to moisture or condensed water. In current electric batteries or battery modules, condensed water occurs frequently, in particular, if the battery cells contained (e.g. lithium ion cells or the like) are cooled actively if required. However, condensed water does not impair the optical signal transmission quality in the area of a plug-in connector of the optical waveguide. In the case of conventional electric plug-in connectors, both the individual wires and the entire connector had to be protected correspondingly. In addition, corrosion of metallic line parts can occur frequently in conventional electric plug-in connectors.

In contrast, the mechanical contact between the OWG or individual OWG cores in a plug-in connector part (e.g. plug) and corresponding devices in the other plug-in connector part (e.g. socket) is not a “weak point critical” for proper data transmission in an OWG plug-in connector used according to the invention. In addition, the OWG plug-in connectors can be much more compact than the electric plug-in connectors hitherto used. This applies, in particular, when the optical data signal transmission is carried out serially (i.e. via a single OWG core for transmitting the data in one direction) and, as a result, it is possible to save constructional space significantly in the energy storage system.

An additional problem in conventional electric plugs with simple plug-in contacting was the wear due to mechanical loading such as, in particular, vibration during the vehicle operation. As a result, a protective layer of the electric contacts was frequently worn off during their service life and in connection with condensed water, corrosion could occur. This could lead to influence on or corruption of the transmitted data signals up to the breaking-off of communication. In the case of the, e.g., optical signal transmission via OWG according to the invention, the transition from metal to metal is lacking, however. OWG components such as cable, plug, sockets etc. can consist of plastic or glass (preferred for OWGs with a high speed of communication) as a result of which corrosion can be eliminated and corruption of communication or of the data distinctly reduced.

Apart from the battery already mentioned or a battery module containing, e.g., an active temperature control device (cooling and/or heating), the electric components of the electric energy storage system can also include, e.g., at least one current flow control component. Such a current flow control component can be, in particular, a switching element such as, e.g., a relay or a transistor. Such a current flow control component can control, for example, a current flow from or to the battery and can receive the corresponding control signal via one or more OWGs (e.g. from a hybrid controller or battery module controller) in the operation of the energy storage system.

Furthermore, at least one of the electric components of the electric energy storage system can be a sensor component (or generally a “measured-variable detection component”). By this means, a measured variable (e.g. voltage, current, temperature, moisture etc.) can be detected and transmitted as optical data signal via at least one OWG.

Furthermore, at least one of the components of the energy storage system can represent a control component for controlling at least one other one of the components. Such a control component can be formed, e.g., by the hybrid controller already mentioned or battery module controller, respectively. Such a control device can have both optical inputs and optical outputs for corresponding data signal transmissions.

Within the electric energy storage system, various components of the component types mentioned above can also be constructionally combined. For example, a battery module intended for energy storage can have both the actual energy store (e.g. battery cell arrangement) and sensors such as, e.g., voltage and temperature sensors, for the individual battery cells.

The electromagnetic or optical data signal transmission according to the invention, for example by means of a respective data transmission line, can take place unidirectionally or bidirectionally.

In this arrangement, the data can be transmitted either serially (only one OWG core per direction) or in parallel (multiple OWG cores per direction).

It is particularly in the case of energy stores having a high number of electrochemical or electrostatic energy stores of the conventional type that the electric cable tree for measuring operating parameters such as, e.g., individual voltages and temperatures, assumed considerable dimensions. This was associated with a not negligible weight. In contrast, the use of fiber optics according to the invention, for example with plastic fibers or glass fibers can lead to a noticeable saving in weight, particularly in the case of serial data signal transmission.

Conventional electronic bus systems which exceeded a certain length and were still intended to transmit data at a high speed often used the so-called LVDS (low voltage differential signaling) technology which, however, doubled the necessary number of cables. The use of fiber optics according to the invention renders the expensive type of transmission obsolete, particularly in the case of long signal paths in this field of application.

In one embodiment, the data transmission lines comprise at least one optical ring bus having at least one optical waveguide which connects a number of the components of the energy storage system to one another. By this means, data signals can be exchanged via such a ring bus without loss of quality and at a sufficiently high speed and with very high electromagnetic compatibility between the relevant components of the energy storage system (and/or external communication partners).

There are varied possibilities for the actual design of the OWG or OWGs used within the context of the invention in which it is advantageously also possible to access measures, known per se, from the field of fiber optics.

For example, an OWG can contain one or more polymer fibers. Since such materials, as a rule, are only stable up to a temperature of about 85° C., laying them in the engine compartment of the relevant vehicle can only be considered to a limited extent, however. In the case of plastic optical waveguides, the restricted bending radius often also presents problems.

In an embodiment preferred for this reason, at least one of the OWGs is constructed as glass fiber OWG cable. A further advantage of glass fibers in comparison with plastic fibers consists in that, as a rule, higher data transmission rates are possible by this means.

It is particularly in the case of operationally provided data transmission rates of more than 0.5 gigabits per second that a laser diode or laser diode arrangement (for multi-core OWGs) is preferred for the relevant OWG as light source.

The use of “board-to-board” plug-in connectors with fiber optics can also be applied in the context of the invention, for instance for producing a connection between various electric circuit carriers or boards of the energy storage system.

In a further embodiment, it is provided that at least one of the optical waveguides is combined with at least one electric conductor for the electric energy transmission and/or electric data signal transmission.

By means of such a “combined optical waveguide”, electric power can thus also be advantageously transmitted or energy storage components supplied.

One possible implementation is the use of a conductive metal (e.g. aluminum, copper, silver, gold etc.) or metal alloy in the form of one or more electric lines which surround the actual OWG or run adjacent to it. As well, e.g. an electric conductor (or an electric line arrangement of a number of individual conductors) for supplying energy can be surrounded, e.g. braided, with the actual OWG (one or more optical fibers). Furthermore, an electric conductor can be vapor-deposited e.g. on the OWG or its fiber(s). In all the variants of embodiments mentioned, an additional protective sheath or a casting (e.g. of plastic) can be advantageously provided. By this means, the metal or the metal alloy for the transmission of electric voltage or power (e.g. supply) is insulated and protected sufficiently against corrosion. Due to the combination of OWG and electric conductor, the energy and data signal transmission can be separated. The data signals can be transmitted by using the fiber optics without the problems mentioned initially of the conventional electric signal transmission technology or contacting.

Due to this technology, it is also possible to save space and weight.

A further possibility of solving the problem of simultaneous energy transmission in addition to signal transmission in the energy storage system via OWG is the use of tin(IV) oxide. From tin(IV) oxide, optical waveguides can be easily produced, the transmission of electric power being additionally provided for, particularly with suitable doping, e.g. with indium. An optical waveguide which in this manner simultaneously represents an electric conductor can thus be used for transmitting energy and signals without, e.g., corrosion representing a problem for the optical signal transmission. One variant of such a “combined line” consists in the use of a conductive coating of doped tin oxide, e.g. indium tin oxide, for example in the form of nanoparticles, on a flexible optically transparent cable for forwarding the information of the light and of the electric energy through the coating.

In summary, the invention provides for an interference-proof data signal transmission and possibly also transmission of electric power in electric energy storage systems of a vehicle equipped with an electric drive. In this context, only optical waveguides and/or (electrically and optically) combined lines can be used. The invention is particularly of interest for use in a hybrid vehicle including plug-in hybrid vehicle or a pure electric vehicle. By using fiber optics and using OWG plug-in connectors, distinctly more reliable energy storage systems of lighter weight can be built, no influence by electromagnetic waves being produced and disadvantageous corrosion in the area of data transmission connections being preventable.

In the text which follows, the invention will be described further by means of exemplary embodiments, referring to the attached drawings, in which:

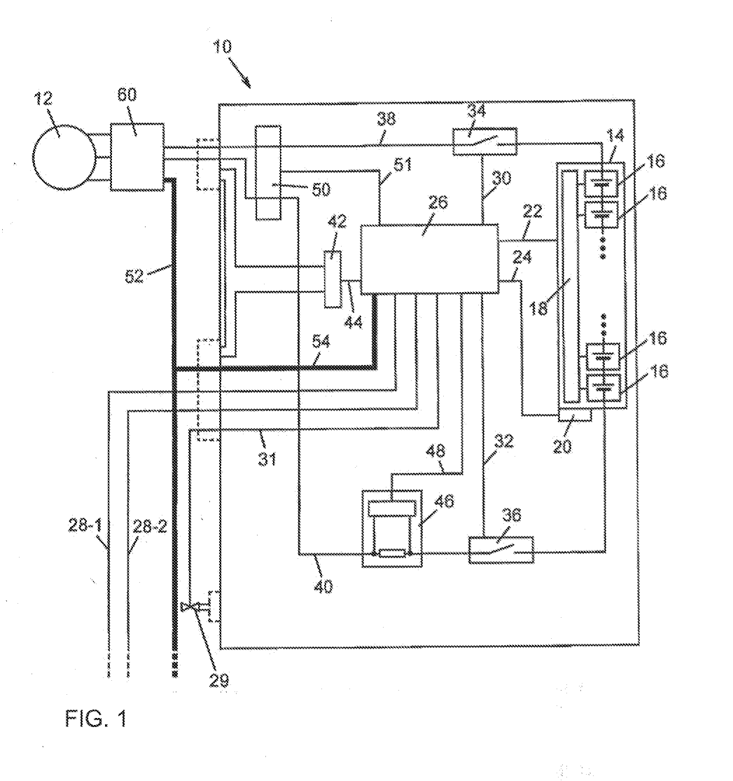

FIG. 1 shows an electrochemical/electrostatic energy storage system of a vehicle equipped with an electric drive,

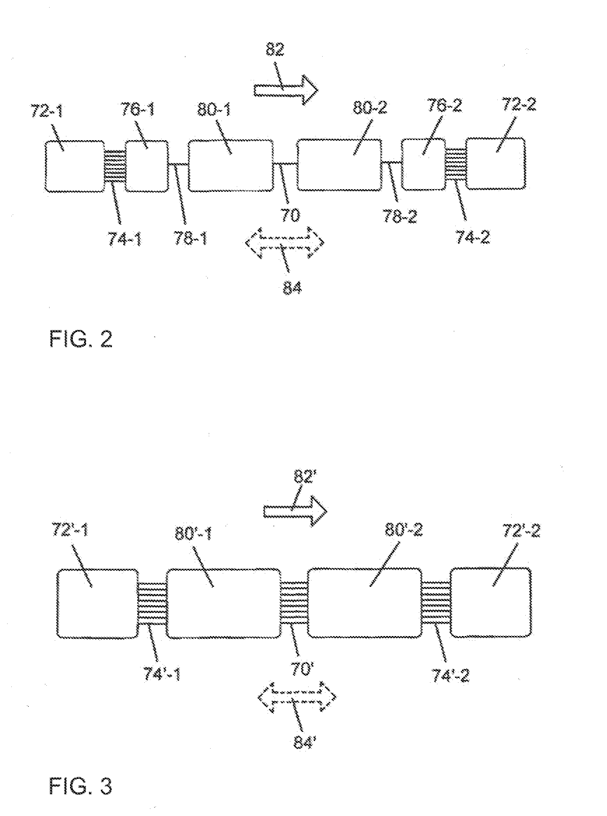

FIG. 2 shows a basic representation of a serial optical data transmission,

FIG. 3 shows a basic representation of a parallel optical data transmission,

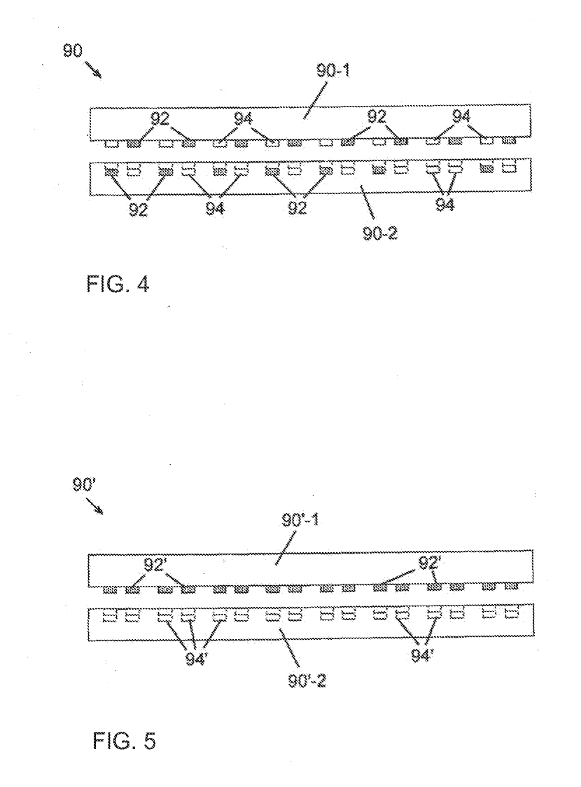

FIG. 4 shows an optical waveguide plug-in connector for bidirectional data transmission,

FIG. 5 shows an optical waveguide plug-in connector for unidirectional data transmission,

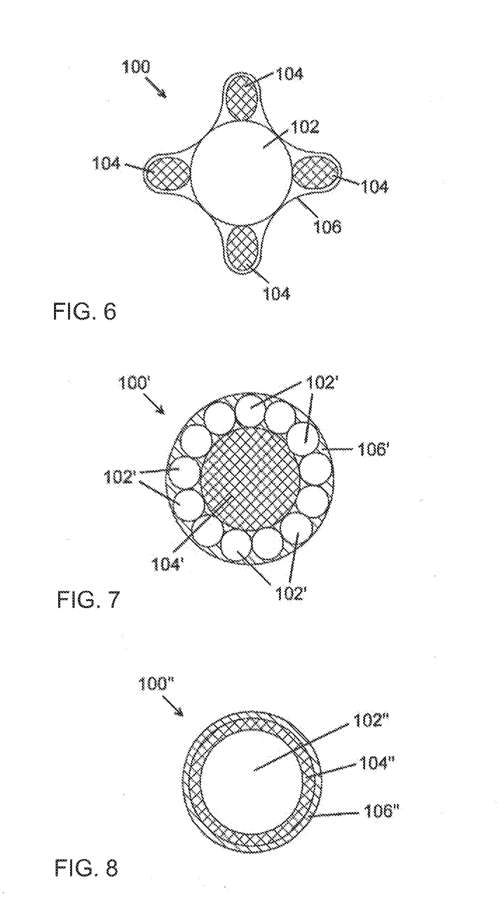

FIG. 6 shows a cross sectional view of a combination of an optical waveguide and multiple electric conductors,

FIG. 7 shows a cross sectional view of a combination of multiple optical waveguides and an electric conductor, and

FIG. 8 shows a cross sectional view of a combination of an optical waveguide and an electric conductor.

FIG. 1 shows a schematic block diagram of an electro-chemical/electrostatic energy storage system 10 of an electric vehicle equipped with an electric motor 12.

The energy storage system 10 comprises a multiplicity of electric components which are described in detail in the text which follows, wherein the present description is to be understood only by way of example and the actual number, type and interaction of these components can be modified in practice in accordance with the respective application, in deviation from the exemplary embodiment shown.

One essential component of the energy storage system 10 shown is a battery module and/or a module of double-layer capacitors (DLC) 14 comprising a multiplicity of interconnected battery cells and/or double-layer capacitors 16, e.g. more than 100 serially interconnected lithium ion cells or the like.

Furthermore, the battery module 14 contains a monitoring device 18 for monitoring the condition and the operability of the individual battery cells 16 (e.g. detection of cell voltages, cell temperatures, battery parameters such as “SOC”, “SOH”, “SOF” etc.), and possibly for effecting measures at individual ones of the battery cells 16 (e.g. so-called battery cells/double-layer capacitors (DLC) matching/balancing etc.).

Finally, a temperature sensor 20 for measuring the battery temperature is also constructionally combined with the battery module 14.

The “monitoring device 18” and “temperature sensor 20” components thus form subcomponents, as it were, of the larger component of “battery module/double-layer capacitor module 14” of the energy storage system 10.

The battery module/double-layer capacitor module 14, more precisely its monitoring device 18 and its temperature sensor 20, is connected for data transmission to a battery module control unit (“module controller”) 26 via lines 22 and 24, respectively.

This control unit 26 monitors and controls the operations of other components of the system 10 and is supplied with operating voltage (e.g. 14 V from a low-voltage vehicle system) via supply lines 28-1 and 28-2.

Via line 22, data signals, e.g. relating to individual cell voltages and/or DLC voltages and/or cell temperatures and/or DLC temperatures etc., can be transmitted from the monitoring device 18 to the control unit 26. Via line 24, a data signal representative of the battery temperature and/or DLC temperature can be transmitted to the control unit 26. Depending on the battery temperature and/or DLC temperature measured, active cooling of the energy storage system 10 (and thus, in particular, of the battery contained therein) can be initiated by the control unit 26. This is symbolized in FIG. 1 by a coolant inlet valve 29 which is driven via a line 31.

The control unit 26, e.g. containing a program-controlled computer device (e.g. microcontroller) also controls switching elements 34 and 36 controllable via lines 30 and 32 which are arranged in the course of battery connecting lines 38 and 40, respectively (e.g. in a “main breaker”) in order to optionally connect the battery module 14 to a high-voltage vehicle system, or to separate it from it.

Such a separation can be initiated, e.g. for safety reasons, by a so-called high-voltage interlock loop (HVIL) monitoring device 24 which is in communication connection with the control unit 26 via a line 44 for this purpose. With regard to the operation of the monitoring device 42 reference is only made to DE 10 2008 021 542 AI by way of example.

Furthermore, arranged as a further electric component of the energy storage system 10 is a current measuring device 46 for measuring the current flowing into the battery module 14 or out of the battery module 14 in the course of the battery connecting line 40 and which is connected to the control unit 26 via a line 48. Thus, a data signal representing the current value detected by sensor can be transmitted via line 48.

In the course of the battery connecting lines 38 and 40, a so-called insulation-fault detector 50 is also arranged which is connected to the control unit 26 via a line 51.

To enable the battery module control unit 26 to communicate with external devices of the vehicle electronics, for example other control units, this control unit 26 is also connected to an electronic communication bus (CAN bus) 52. The connection is effected via a CAN line 54. As an alternative or additionally, the CAN bus 52 could also be conducted to other components of the energy storage system 10.

A number of plug-in connections which connect the energy storage system 10 to the “outside world” are drawn dashed in FIG. 1.

The CAN bus 52 is also connected to a DC/AC inverter 60 in order to control and monitor its operation. By means of the inverter 60, electric power taken from the battery module 14 as direct current can be converted in the illustrated example into multi-phase alternating-current power for driving the electric motor 12 constructed here, e.g., as three-phase electric machine. If regenerative braking (recuperation of braking energy) is provided in the vehicle, power generation and retransmission into the battery module 14 can also be effected by using the electric motor 12 as electric generator and driving the inverter 60 correspondingly.

When the energy storage system 10 is in operation, considerable electric currents (e.g. of the order of magnitude of some 100 A) and correspondingly also considerable current changes may occur in dependence on the actual operating situation. To avoid an associated impairment of the various data signal transmissions already explained above (“EMC problems”), in particular, a special feature of the energy storage system 10 consists in that the data transmission devices formed by the individual data signal lines comprise at least one optical waveguide (OWG) for the optical data signal transmission.

A number of the lines provided for the transmission of data signals from and/or to the components of the system 10 are preferably implemented as OWG or in fiber optics (with corresponding electrooptical interfaces at the OWG ends).

In the exemplary embodiment shown, e.g. lines 22, 24, 30, 31, 32, 44, 48 and 51 are constructed as OWGs (in each case containing one or more optical fibers).

Quite generally, it is preferred if at least those lines contained in the system 10 are constructed as OWGs via which the results of a detection of measured variables (sensor values) and/or more or less “precise” driving signals for an “actuator component” are transmitted. For the example shown, this means, e.g., that measured variables detected in the battery module 14 are transmitted preferably via the lines 22 and 24 constructed as OWGs to the battery module control unit 26. The same applies, e.g., to the data signal transmission from the current measuring device 46 to the battery module control unit 26.

Apart from the high quality of signal transmission due to the optical transmission of data signals, the use of light as a signal carrier also results in an advantageous electrical isolation between the respective communication partners.

The respective data exchange can take place unidirectionally or bidirectionally via the optical waveguide depending on the actual requirements. In this context, the data can be transmitted either serially or in parallel. These various options will be explained in greater detail in the text which follows, referring to FIGS. 2 and 3.

FIG. 2 illustrates the principle of a serial data transmission using an optical waveguide 70 consisting of a single optical fiber for the optical transmission of signals in one direction or, respectively, consisting of two such optical fibers in the case of a bidirectional transmission of signals.

Starting from a first communication partner 72-1, e.g. a parallel electric signal transmission 74-1 can take place to a parallel/serial convertor 76-1. The signal converted in this manner can then be supplied by means of electric signal transmission 78-1 to an electrooptical transducer 80-1 which generates from this the optical signal to be output on the OWG 70. After reception of the optical signal by means of an electrooptical transducer 80-2 at the receiver end, serial electric signal transmission 78-2, serial/parallel conversion 76-2 and parallel electric signal transmission 74-2, the data signal reaches a second communication partner 72-2. Arrows 82 and 84 symbolize a unidirectional transmission implemented in this manner (arrow 82) and bidirectional transmission (arrow 84), respectively.

FIG. 3 illustrates in a presentation corresponding to FIG. 2 the principle of parallel data transmission by means of optical waveguides. 72′-1 and 72′-2 designate the first and second communication partner, respectively, 74′-1 and 74′-2 designate electric parallel signal transmissions, 80′-1 and 80′-2 designate electrooptical transducers and 70′ the optical waveguide used, which in this case consists of a number of optical fibers per direction of transmission. The two options of unidirectional or bidirectional transmission, respectively, are symbolized again by arrows 82′ and 84′, respectively.

All parts shown in FIGS. 2 and 3 between one of the communication partners and the relevant optical waveguide are preferably constructionally combined with this communication partner as an interface device. The transition between individual optical fibers or the entire optical waveguide to an electrooptical transducer (transmitter, receiver or transmitter/receiver) can be implemented in each case by an “optical plug-in connector”. Examples of this will still be explained with reference to FIGS. 4 and 5.

The communication partners 72-1, 72-2, 72′-1 and 72′-2, shown in FIGS. 2 and 3, can be, e.g., any electric component, provided for OWG data signal transmission, of the energy storage system 10 shown in FIG. 1. The data signals can be transmitted between two such components within the system 10 and as an alternative or additionally, a signal transmission between a component of the system 10 and an external component of the relevant vehicle electronics can also be provided.

FIG. 4 shows by way of example a “board-to-board” plug-in connector 90 for a bidirectional optical transmission. The plug-in connector 90 consists of a plug 90-1 and a fitting socket 90-2. In the example shown, these two plug-in connector components have in each case a row of laser diodes 92 (as transmitters) and a row of pin diodes 94 (as receivers).

FIG. 5 is an illustration, corresponding to FIG. 4, of a plug-in connector 90′ consisting of a plug 90′-1, equipped only with transmitters 92′, and a socket 90′-2 equipped only with receivers 94′. A unidirectional optical transmission is effected via this plug-in connector 90′.

As can be seen from FIGS. 4 and 5, the fiber optics can optimize the plug-in systems used in a simplifying manner. By means of suitable plastic partitions between the transmitters/receivers, a reliable separation of the individual transmission channels and, as a result, error-free signal transmission can be achieved.

Optical plug-in connectors of the type illustrated in FIGS. 4 and 5 can be used, for example, in the energy storage system 10, represented in FIG. 1, for connecting the lines constructed as OWG to the relevant components of the system 10 (and/or for connecting circuit boards to one another).

The alleged disadvantage of simple fiber optics is that no power can be transmitted via the optical waveguide. To remedy this, a combination of an optical waveguide (containing at least one optical fiber) with at least one electric conductor can be used in the course of the invention in order to combine by this means an optical data signal transmission with an electric energy transmission and/or electric data signal transmission. In the text which follows, exemplary embodiments of such a “combined line” will be explained with reference to FIGS. 6, 7 and 8.

FIG. 6 shows a combined line 100 which is composed of an optical fiber 102 and four electric conductors (cores) 104. 106 designates a protective sheath, e.g. of plastic.

FIG. 7 shows a combined line 100′ composed of a multiplicity of optical fibers 102′ and one electric conductor 104′ which, in the exemplary embodiment shown, forms a large-area core of the combined line 100′. 106′ designates here a casting compound (e.g. synthetic resin).

FIG. 8 shows a combined line 100″, composed of an optical fiber 102″, forming the core, and a layer of an electric conductor 104″ vapor-deposited thereon. A sheathing of the line 100″ is formed by a protective sheath or casting 106″.

As an alternative or additionally to a “purely optical” data signal transmission in the relevant lines of the energy storage system 10 of FIG. 1, such combined lines can thus also be used as are shown by way of example in FIGS. 6 to 8.

In summary, the following advantages can be achieved, in particular, with the use according to the invention of fiber optics in an electric energy storage system of a vehicle:
no sensitivity to electromagnetic influences (possibly dispensing with LVDS).
high-voltage protection or high-voltage safety. In particular, e.g. the safety distance hitherto necessary between individual voltage-conducting parts and the signal lines or cables is omitted.
electrical isolation of the communication partners is made possible, no problems due to corrosion of electric contacts, particularly plug-in contacts.
provision for very high data transmission rates.
reduction of the diameter of cable trees or cable tree branches, particularly in the case of serial data transmission.
provision for a very compact structure of the energy storage system. In addition, a more flexible internal structure of the system is provided for.
weight saving, e.g. by saving reference lines (LVGS) and/or by using plastic or glass fiber OWGs.

1-9. (canceled)

10. In combination with a vehicle equipped with an electric drive, an electric energy storage system for the vehicle, comprising:
a plurality of electric components and data transmission devices for transmitting data signals from at least one of said components and/or to at least one of said components;
said data transmission devices including at least one transmission link for electromagnetic radiation to transmit the data signals.

11. The energy storage system according to claim 10, wherein at least one said transmission link is an optical waveguide for an optical transmission of data signals.

12. The energy storage system according to claim 11, wherein said optical waveguide is connected to a respective component via a plug-in connector.

13. The energy storage system according to claim 11, wherein said optical waveguide forms a combination with at least one electric conductor for transferring electric energy and/or transmitting data signals.

14. The energy storage system according to claim 10, wherein at least one said transmission link is an optocoupler.

15. The energy storage system according to claim 10, wherein at least one of said components is a storage component for storing electric energy.

16. The energy storage system according to claim 15, wherein said storage component for storing electric energy is an electrochemical energy storage device or an electrostatic energy storage device.

17. The energy storage system according to claim 10, wherein at least one of said components is a current flow control component.

18. The energy storage system according to claim 10, wherein at least one of said components is a sensor component.

19. The energy storage system according to claim 10, wherein at least one of said components is a control component configured for controlling at least one other one of said components.
